(19) United States
(12) Patent Application Publication
(10) Pub. No.: US 2005/0043868 A1
(43) Pub. Date: Feb. 24, 2005

(54) Vehicle on-board reporting system for state emissions test

(76) Inventor: Arvon L. Mitcham, Ypsilanti, MI (US)

Correspondence Address: LORUSSO, LOUD & KELLY, 3137 Mount Vernon Avenue, Alexandria, VA, 22305, US

(21) Appl. No.: 10/887,325

(22) Filed: Jul. 9, 2004

Related U.S. Application Data
(60) Provisional application No. 60/485,388, filed on Jul. 9, 2003.

(51) Int. Cl. G06F 19/00

(52) U.S. Cl. 701/29; 701/33; 340/438

(57) ABSTRACT

In a vehicle on-board reporting system for state emissions tests, the vehicle is provided with a removable media storage device 40 and a radio responder device 42 mounted in the vehicle for transmitting data to and from a remote location. A user interface 32 is mounted in the vehicle and connected to a control module 20 which includes a vehicle identification number 29, diagnostic facilities 22 for receiving data from emission related sensing devices on the vehicle and for determining a malfunction from the received data, an erasable/recordable non-volatile memory 26 for storing diagnostic trouble codes and facilities 30 responsive to a user request for reading the vehicle identification number and the stored diagnostic trouble codes and transmitting the vehicle identification number and emissions information to an output of the control module. The user interface includes a message display 34 and user data entry facilities 36 for sending the user request to read and output the stored diagnostic trouble codes and for selectively connecting one of the removable media storage device 40 and the radio responder 44 to the output of the control module to send emission test data to a state vehicle licensing authority via a recordable media or a radio transmission facility.

### CROSS-REFERENCE TO RELATED APPLICATION

This application claims priority under 35 U.S.C. 119(e) of U.S. Provisional Patent Application No. 60/485,388 filed Jul. 9, 2003 entitled On-Board, Mobile, Combined Event Recorder, Flight Recorder and Telematic System/Device for Automotive/Vehicle Applications and which is incorporated by reference herein in its entirety.

### BACKGROUND OF THE INVENTION

Vehicles include on-board diagnostic (OBD) systems such as On-Board Diagnostic II (OBD II) systems which monitor various sensors indicating status of vehicle components and operating conditions including emission control components and their operation. Typically the OBD system is included as part of a control module (CM) such as an engine control module (ECM) or powertrain control module (PCM) and includes an erasable electronic programmable read-only memory (EEPROM) or electronic programmable read-only memory (EPROM) in which diagnostic trouble codes (DTC) are recorded when a malfunction is detected. The OBD system also controls a malfunction indicator light (MIL) such as a “Check Engine” or “Service Engine Soon” light to indicate that there is a problem in the emission control system or other system of the vehicle.

A standard multi-pin connector such as the Data Link Connector (DLC) is provided in the vehicle for connecting the BCD system to a diagnostic device which can read the recorded DTC digital codes and indicate which components or operations are malfunctioning. Also the prior art includes data loggers or recording devices which can be connected to the DLC to record temporary malfunctions which periodically occur during operation of a vehicle but are subsequently cleared by OBD system. The data recorded by the data logger can be analyzed to diagnose a vehicle problem. Additionally some manufacturers provide radio or telecommunication equipment in vehicles which can transmit information to a central location to diagnose a vehicle problem. Radio communication devices for connection to the DLC and remote transmission of DTC codes to maintenance equipment are also commercially available.

Mandated annual or biennial emission tests are conducted by state or state-authorized testing stations and typically include the placement of a probe into the exhaust pipe of a vehicle and the determination of the concentration of various pollutants such as NOₓ, CO, particulates and hydrocarbons in the exhaust gas during operation of the vehicle on a dynamometer. In lieu of the exhaust probe emission test, several states now utilize or authorize equipment which connects to the DLC, reads the DTC codes and analyzes the codes to determine if a vehicle meets emission requirements; this substantially reduces emission testing time compared to the procedures involved in conducting an exhaust probe test. Test results are often communicated directly to a state vehicle licensing department over telephone lines connected to the testing equipment.

It is an object of the present invention to enable further simplification along with time and cost reduction in the periodic emission testing of vehicles for state mandated tests to determine if vehicles meet pollutant emission requirements.

### BRIEF SUMMARY OF THE INVENTION

The invention is summarized in a vehicle on-board reporting system for state emissions tests wherein the vehicle is provided with a removable media storage device and a radio responder device mounted in the vehicle for transmitting information relative to an emission test to and from a remote location. A user interface is mounted in the vehicle and is connected to a control module which includes a vehicle identification number, diagnostic facilities for receiving data from emission related sensing devices on the vehicle and for determining a malfunction from the received data, an erasable/recordable non-volatile memory for storing diagnostic data and facilities responsive to a user request for reading the vehicle identification number and the stored diagnostic data and transmitting the vehicle identification number and information regarding stored diagnostic data relating to emissions to an output of the control module. The user interface includes a message display and user input facilities and is responsive to operation of user input for sending the user request to read and output the stored diagnostic trouble codes and for selectively connecting one of the removable media storage device and the radio responder to the output of the control module. Thus the identification number and the information regarding stored diagnostic data relating to emissions can be sent to a state vehicle licensing authority via a recordable media or a radio transmission facility.

In one particular embodiment, stored diagnostic data includes diagnostic data codes.

Additionally the vehicle may include a external port so that the user interface can selectively connect one of the removable media storage device, the radio responder and the external port to the output of the control module whereby the identification number and the information regarding stored diagnostic trouble codes relating to emissions can be sent to a state vehicle licensing authority via a recordable media, a radio transmission facility or a station which can be connected to the external port.

Further the diagnostic trouble codes in the erasable/recordable non-volatile memory may be manufacturer specific codes and the facilities responsive to a user request for reading the vehicle identification number and the stored diagnostic trouble codes and transmitting the vehicle identification number and information regarding stored diagnostic trouble codes relating to emissions to an output of the control module translates the manufacturer specific codes to a standard code.

### BRIEF DESCRIPTION OF THE DRAWINGS

FIG. 1 is a block diagram of a vehicle on-board reporting system of state emissions test in accordance with the invention.

FIG. 2 is a block diagram of another variation of the system of FIG. 1.

FIG. 3 is a process diagram of a procedure employed in a diagnostic client of the system of FIG. 1 of the OBD system of FIG. 2.

FIG. 4 is a diagram of a further variation of the vehicle on-board reporting system of state emission test in accordance with the invention.

FIG. 5 is a diagram of a still further variation of the vehicle on-board reporting system of state emission test in accordance with the invention.

### DETAILED DESCRIPTION OF THE INVENTION

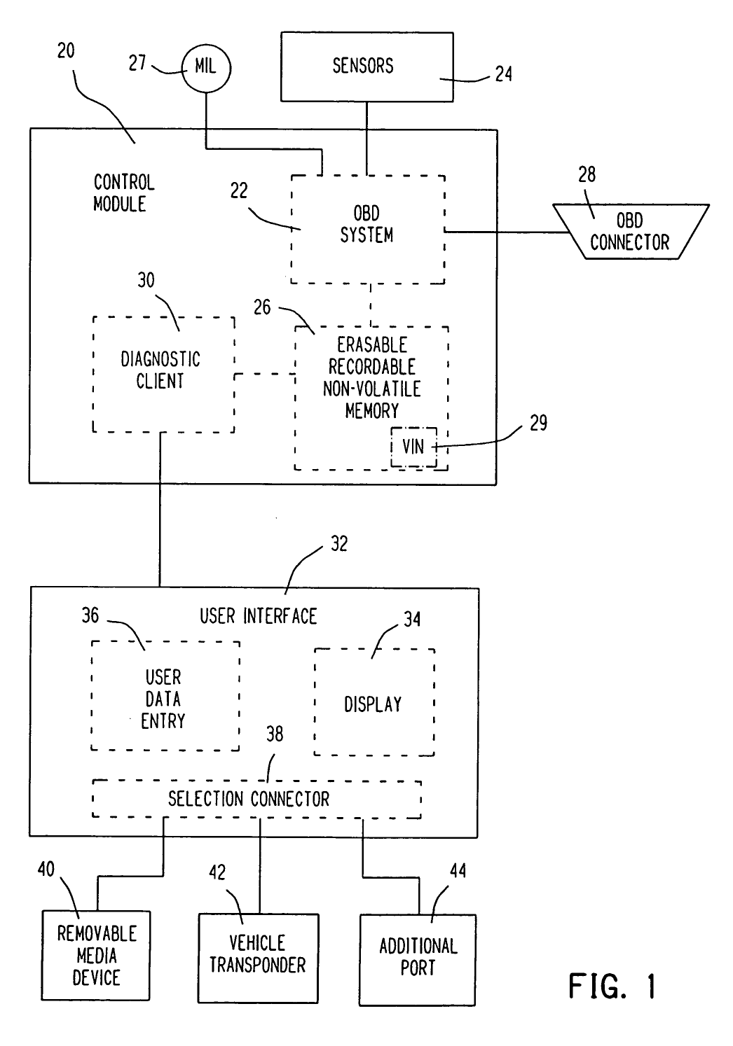

As shown in FIG. 1, a vehicle on-board reporting system for state emissions test contains a control module 20 which contains an on-board diagnostic (OBD) system 22 connected to a plurality of sensors 24, to an erasable/recordable non-volatile memory 26 and to a malfunction indicator light (MIL) 27 commonly known as the “check engine” light. A vehicle identification number (VIN) 29 is also fixed in the control module 20 such as in the memory 26. The OBD system 22 is a conventional system such as an OBD II system employed in vehicles for analyzing the signals from the sensors 24 to detect any malfunction in various components and operations of the vehicle including components and operations controlling pollutant emissions from the vehicle, to store diagnostic data such as diagnostic trouble codes (DLC) and other information in the memory 26 identifying detected malfunctions and to operate the MIL 27. An example of a stored DLC relating to pollutant emission control would a DLC code indicating an exhaust O₂ level outside of a normal range. Included in the conventional system is a standardized sixteen-pin connector 28 connected to the OBD system 22 for connecting the system to conventional external diagnostic equipment (not shown) enabling the external diagnostic equipment to request and receive a read out of the diagnostic codes and other data stored in the memory 26. Various other data such as MIL status, odometer mileage, readiness status of sensors, calibration verification numbers (CVN), calibration identification (Cal ID), engine and vehicle speed data, fuel pressure, etc. is stored and periodically updated in the memory 26 or other temporary memory of the control module. Several data items in addition to MIL status and the stored DLC in the CM 20 are indicators of vehicle emissions and can be used in determination of whether the vehicle meets emission requirements.

The control module 20 differs from a conventional control module by including a diagnostic client 30, such as an additional microprocessor, which is connected to the memory 26 and a user interface 32 mounted in the vehicle and which can generate a request to the client 30 to read the codes stored in the memory 26 and to send information relative to emission testing to the user interface 32. A display 34 and user data entry means 36, such as a plurality of buttons, voice recognition facilities or a touch screen, are provided in the user interface 32 for enabling the user to operate the interface and request the emission test information. Additionally, the user interface 32 includes a selection connection 38 which, in response to corresponding operation of the buttons 36 by the user passes the emission test information to a selected one of a removable media recording device 40, a vehicle responder 42 and an additional port or ports 44.

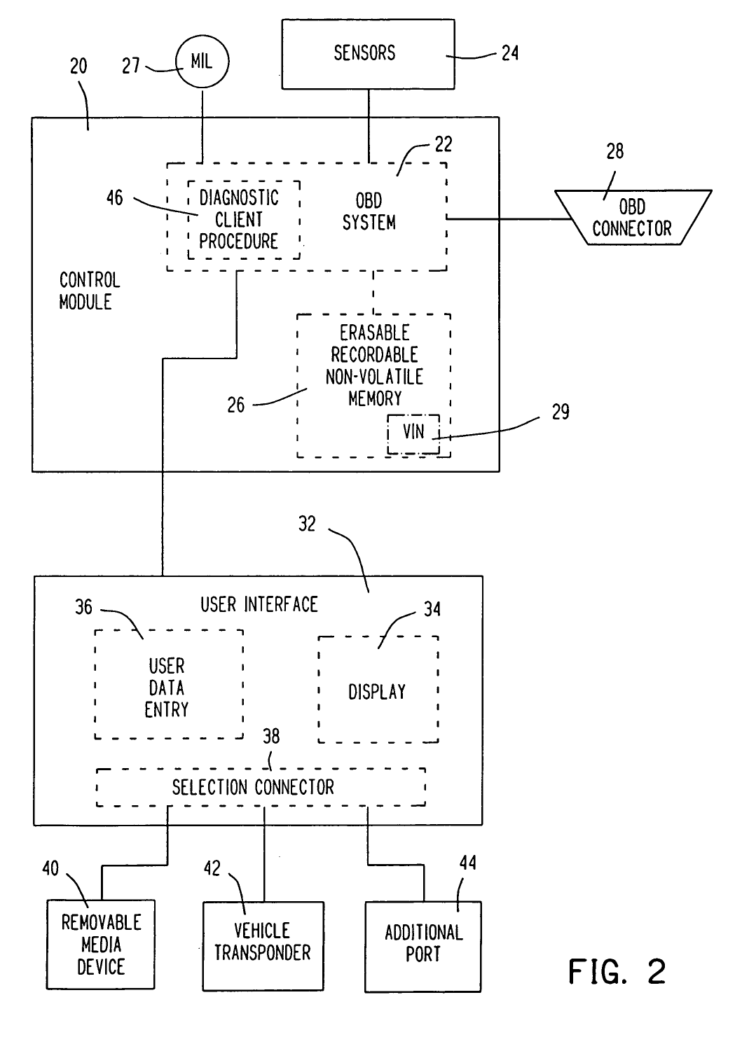

A variation or modification of the on-board emissions test reporting system is shown in FIG. 2. In this variation the conventional OBD system 22 is modified to include a diagnostic client procedure 46 which performs the functions of the diagnostic client 30 of FIG. 1.

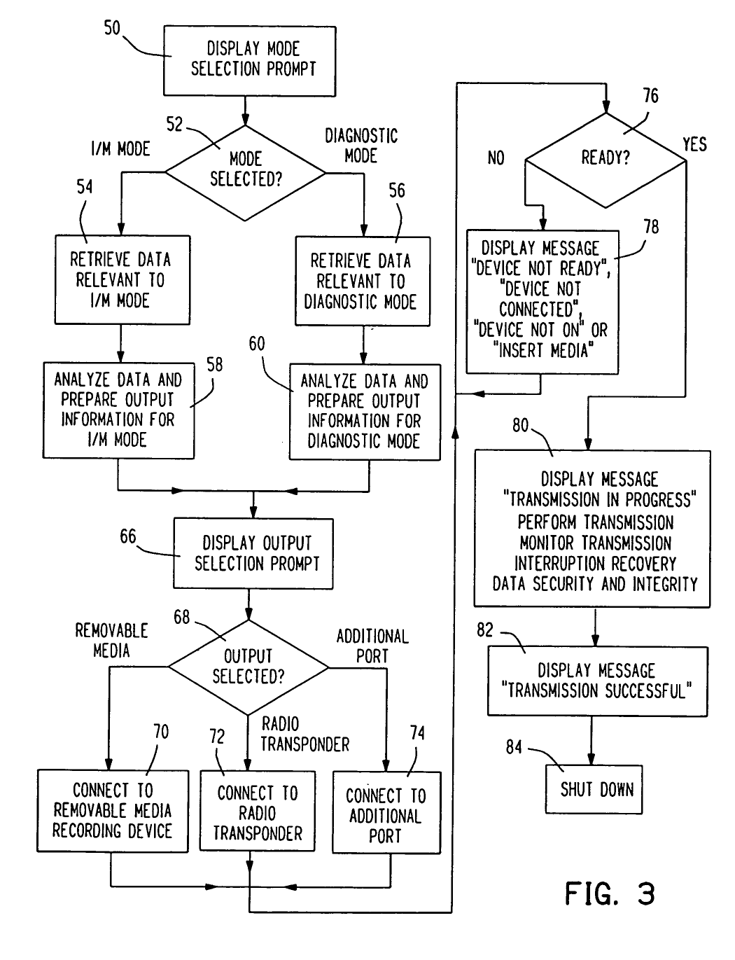

As shown in FIG. 3, a procedure programmed in the diagnostic client 30 of FIG. 1 or the OBD system of FIG. 2 is initiated by a user operating the user data entry 36 such as pressing a start button, etc. Initially the procedure in step 50 displays on the display 34 a selection prompt for the user to select a mode of operation. There are two modes namely, I/M mode and a diagnostic mode. The I/M mode is the mode used to record or transmit information relative to an emissions test to a state authority, and the diagnostic mode is a user friendly mode to record or transmit user friendly diagnostic information of the vehicle. When the user makes a mode selection by the user data entry 36, step 52 branches either to step 54 of the I/M mode or step 56 of the diagnostic mode. In the I/M mode, step 54 retrieves data from the memory 26, and possibly additional sources, relevant to the I/M mode and step 58 analyzes the retrieved data along with preparing output information required for the emissions test. The format and content of the emission test information will be in accordance with a government standard. Although there are proposed universal standards (SAE J2012, SAE J1979, etc.) for diagnostic trouble codes (DTC), manufacturers often do not follow any universal standard but employ DTC specific to the manufacturer's need; step 58 converts of such manufacturer specific DTC to a government mandated universal DTC or term for reporting an emission test. In the diagnostic mode, step 56 retrieves data relevant to vehicle operation and malfunctions that could possibly be helpful in diagnosing a vehicle problem or informing the user of maintenance status. In step 60, the relevant diagnostic data is converted to user friendly information which can be readily understood by the user; any stored diagnostic trouble code (DTC) would be converted from its five-digit hexadecimal form to a readily understandable descriptive term.

After preparation of suitable output information, step 66 displays a prompt on the display 34 for the user to select an output to the removable media device 40, the transponder 42 or the port 44. The selection made by the user by the user data entry 36 is detected in step 68 to branch to the corresponding step 70, 72 or 74 where the selection connector 38 is operated to connect to the removable media recording device 40, the vehicle transponder 42 or the port 44. The steps 70, 72 or 74 also provide for initialization, warmup, etc. of the appropriate connected device. In step 76, a failure to establish communication with a device is detected to branch to step 78 where a message appropriate to the failure is displayed, for example one of the messages “device not ready”, “device not connected”, “device not on”, “insert media”, etc. If the step 76 finds the connected device ready, step 80 displays a message such as “transmission in progress” and performs the transmission. Also step 80 monitors the transmission process and performs required and/or desirable transmission procedures such as interruption detection and recovery, data security for example encryption and a transmitted data integrity check. After step 80 is completed, step 82 displays the message “transmission successful” and step 84 terminates the procedure.

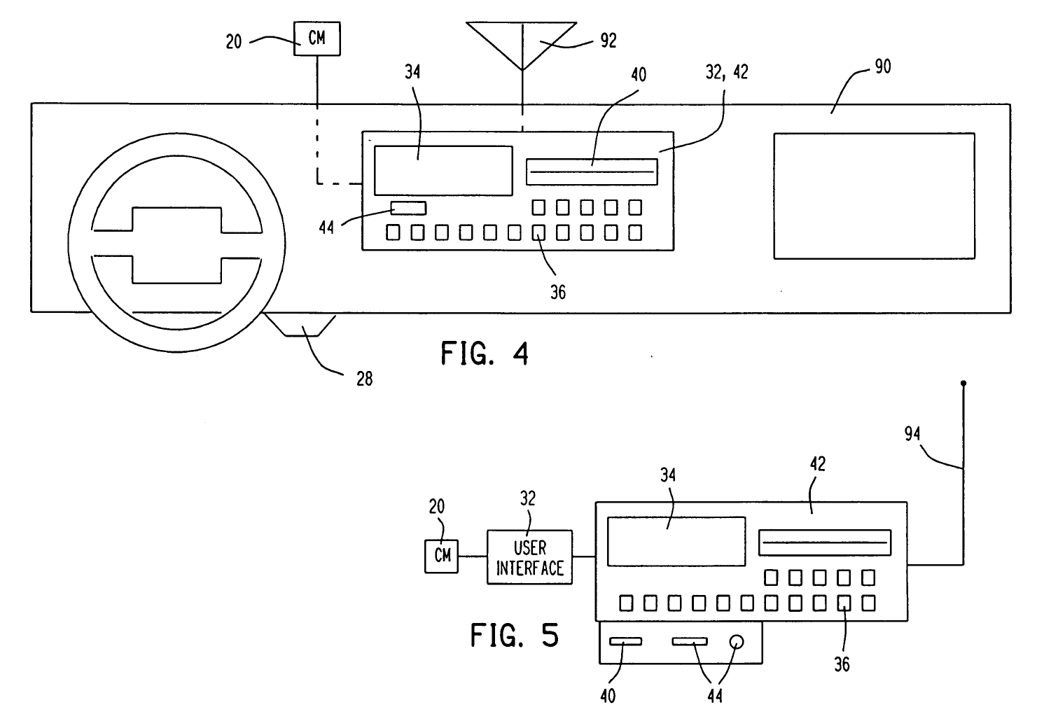

In a further variation in FIG. 4, the user interface 32 and transponder 42 are shown incorporated in a radio unit mounted in the dashboard 90 of the vehicle. The display 34 and buttons 36 are jointly used for radio/CD play functions. In this variation, the media recording device 40 is a CD read/write (RW) device which replaces the normal CD play of the car radio. The external port 44 is conveniently also in the dashboard unit. The radio circuitry is modified in a conventional manner to provide transponder operation through an antenna 92 to localized or satellite units.

In a still further variation of FIG. 5 a dashboard radio unit provides the transponder circuitry 42 for radio transmissions and receiving through the conventional radio antenna 94. The interface unit 32 utilizes the display 34 and the buttons 36 of the radio unit for display and user input functions so that the display 34 and the buttons 36 serve double duty for radio/CD play operation and user interface. The media recording device 40 and the additional ports 44 are mounted in a separate unit in the dashboard.

The OBD system 22 of vehicles is usually contained in an engine control module (ECM) or a powertrain control module (PCM). However this OBD system 22 can be contained in a separate module or any other module of the vehicle.

The removable media recording device 40 is any one of a variety of devices designed to record data such as compact disk CD or digital video disk (DVD) read/writers which can optically write data on CD-R and/or DVD-R media and CD-RW and/or DVD-RW media, floppy disk drives which can read and write data on magnetic disks such as 3.5 inch disks, Mini-Disks, Zip disks or removal hard drives, digital recorders which can read and write data on non-volatile memory media such as SmartMedia cards, CompactFlash cards, Sony Memory Stick, SD cards, Multimedia cards, and IBM MicroDrive cards, printers with optional scanners which can print barcodes, multiline codes or other codes on paper cards or sheets suitable for scanning, devices which can read and write data on magnetic stripes of plastic or paper cards, and other devices suitable for writing (and optionally reading) data on media easily transportable through mail.

The vehicle transponder 42 is any one of a variety of devices designed to transmit and receive data via electromagnetic or radio waves either in short range or long range. Many vehicles include transponders which communicate via satellites (long range) or cell phone (short range) to stations which can forward transmitted emission test data to appropriate state vehicle licensing authorities and thus can be utilized as the vehicle transponder 42. Remote radio internet connection devices such as BlueTooth, other network computer connecting devices or technology similar to that employed in automatic toll devices such as EZPass could be used in conjunction with state or privately operated drive-through facilities for emission testing; in this case, the transponder could automatically initiate the reading of emission test data.

The additional port or ports 44 can be conventional serial or parallel data ports. Examples of serial ports include standard serial ports, USB ports, Firewire ports, etc. Additionally video ports could be provided for external display options.

Since many modifications, variations and changes in detail can be made to the embodiments described above, it is intended that the foregoing description and the accompanying drawings be considered as only illustrative and not in a limiting sense.

1. A vehicle on-board reporting system for state emissions tests comprising:
a control module including a vehicle identification number, diagnostic means for receiving data from emission related sensing devices on the vehicle, means for determining a malfunction from the received data, an erasable/recordable non-volatile memory for storing diagnostic data and means responsive to a user request for reading the vehicle identification number and the stored diagnostic data and transmitting the vehicle identification number and emissions information regarding stored diagnostic data relating to emissions to an output of the control module;
a user interface mounted in the vehicle and connected to the control module;
a removable media storage device mounted in the vehicle; and
a radio responder device mounted in the vehicle for transmitting data to and from a remote location;
the user interface including a message display, user data entry means and means responsive to operation of the plurality of keys for sending the user request to read the stored diagnostic data and output the emissions information and for selectively connecting one of the removable media storage device and the radio responder to the output of the control module;
whereby the identification number and the emissions information regarding can be sent to a state vehicle licensing authority via a recordable media or a radio transmission facility.

2. A vehicle on-board reporting system for state emission tests as claimed in claim 1 wherein the stored diagnostic data includes stored diagnostic trouble codes.

3. A vehicle on-board reporting system for state emissions tests as claimed in claim 2 wherein the diagnostic trouble codes are manufacturer specific codes and the means responsive to a user request for reading the vehicle identification number and the stored diagnostic trouble codes and transmitting the vehicle identification number and information regarding stored diagnostic trouble codes relating to emissions to an output of the control module includes means for translating the manufacturer specific codes to a standard code.

4. A vehicle on-board reporting system for state emissions tests as claimed in claim 1 further including a external port mounted in the vehicle and the means responsive to the operation of the plurality of keys selectively connects one of the removable media storage device, the radio responder and the external port to the output of the control module whereby the identification number and the emissions information can be sent to a state vehicle licensing authority via a recordable media, a radio transmission facility or a station which can be connected to the external port.
